(19) United States
(12) Patent Application Publication
(10) Pub. No.: US 2010/0034255 A1
(43) Pub. Date: Feb. 11, 2010

(54) TELEVISION APPARATUS AND METHOD FOR COLLECTING FIELD DATA

(76) Inventor: Herve Guihot, Mountain View, CA (US)

Correspondence Address: NORTH AMERICA INTELLECTUAL PROPERTY CORPORATION, P.O. BOX 506, MERRIFIELD, VA, 22116, US

(21) Appl. No.: 12/188,184

(22) Filed: Aug. 7, 2008

(51) Int. Cl. H04N 7/12

(52) U.S. Cl. 375/240.01; 375/E07.076

(57) ABSTRACT

For collecting test data from different locations, one or more television apparatuses are disposed in different locations. In addition to decoding and playing received television stream, these television apparatuses contain sample generators for generating test samples based on the received television stream. To downsize the test samples, parts of the received television stream are replaced with placeholders. In addition, copyright materials may be removed and not contained in the test samples. These test samples are transmitted to a remote server via an upstream channel or a network other than a television network under test. With these test samples, a test television stream can be reconstructed to know signal characteristics and/or processing quality of the television apparatus under test.

### BACKGROUND

Digital television is a trend around the world and there are different digital television standards. Even with the same television standards, there are many broadcasting stations for broadcasting television signals to television receivers. The signal characteristics and signal content may change because of different machines made by different companies disposed in these broadcasting stations even with the same original television signal to be broadcasted. In addition, weather conditions and geographical features may also influence television signals finally received at television receivers. Therefore, to design a television apparatus, e.g. a television or a set top box or any other television receivers, field trial is usually necessary step.

The problem is that it takes a lot of money and time for performing field trial. Usually, field trial engineers bring a prototype television traveling around a selected area, install the prototype television and collect television signals at different locations. These received television signals may be recorded for further analysis and experiments. Sometimes, field trial engineers even need to adjust settings of the prototype television and check whether such adjustments improve signal receiving in that area. If to test a television apparatus in a big country like United States of America, field trial may take months but still cover limited area.

Plus, signal characteristics may vary at different time. For example, signal characteristics may be different in winter and in summer because wireless transmission may be affected by different weather condition. Sometimes, field data collected for the field trial in a morning may be different from that collected in the afternoon. It adds further difficulty on traditional field trial.

Collecting detailed and complete field data, however, helps optimizing design of television apparatuses. It would be advantageous if a better way for collecting field data can be figured out.

### SUMMARY OF THE INVENTION

In a first embodiment according to the invention, a television apparatus, e.g. a television, a set top box, a television card or any other television receiver, contains a television player for decoding and playing a received television stream. The television apparatus also has a sample generator and an output device. The sample generator is used for generating test samples based on the received television stream, and the test samples, which reflect signal characteristics of the received television stream and/or processing of the television player, may be used as field data for further analysis and experiments. The output device sends the test samples to a remote server via an uplink channel of a television network or a network, e.g. Internet, other than a television network. Preferably, copyright materials may be removed from the received television stream to generate the test samples. Moreover, placeholders may be used for replacing certain contents of the received television stream for downsize transmission amount of the test samples.

The television apparatus may generate and send the test samples to the remote server automatically according to a setting or the television apparatus may be designed with a switch that activate generating and outputting test samples according to a command received from the remote server.

In another embodiment according to the invention, a method for performing field trial contains following steps. First, television apparatuses with test function are disposed at different locations. These television apparatuses may look just like other television apparatuses available in the market and buyers for these special television apparatuses with test function may be provided with a special discount for compensating collecting test data with the television apparatuses they buy. Second, test samples, which are generated at these television apparatuses which are disposed at different locations, are collected at a remote server. Third, these test samples are analyzed for optimizing the television apparatuses or performing other experiments.

With these embodiments, field trial can be carried out in a more efficient and effective manner so as to help design better televisions or broadcasting stations to improve human life.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates components arrangement for collecting field data;

FIG. 2 illustrates an exemplary television apparatus;

FIG. 3A illustrates generation of test samples;

FIG. 3B illustrates reconstruction of test samples into a test television stream;

FIGS. 4A, 4B and 4C illustrates different interaction approaches between a remote server and a television apparatus; and

FIG. 5 is a flowchart illustrating a method for collecting field data.

### DETAILED DESCRIPTION

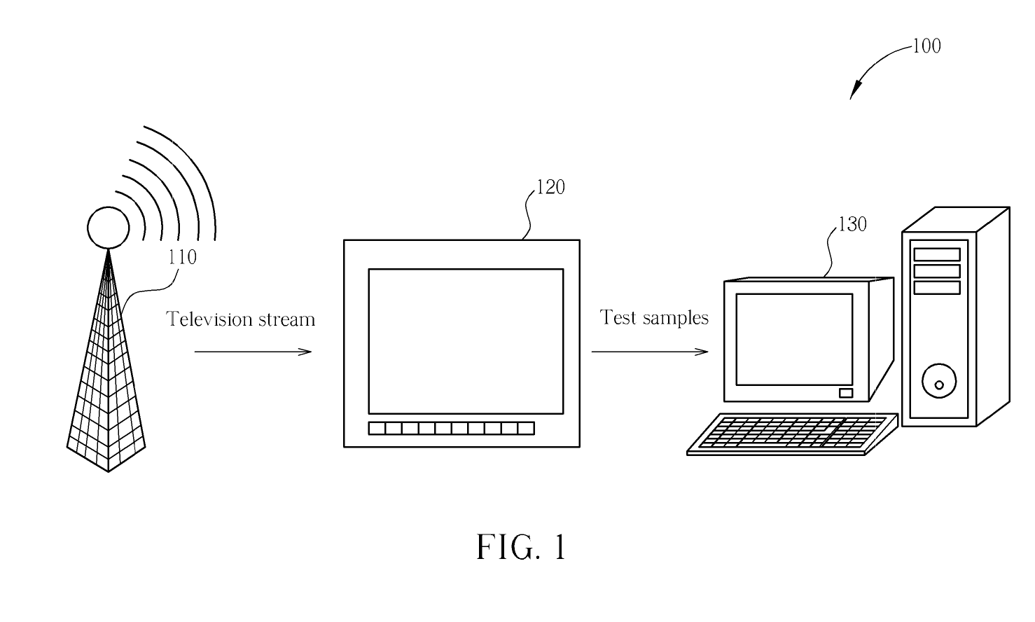

FIG. 1 is a diagram illustrating an example of how to arrange components, i.e. a television broadcasting station 110, a television apparatus 120 and a remote server 130, for collecting television field data used for testing.

A television broadcasting station 110 broadcasts television signals in a coverable area. The television signals, like ATSC (Advanced Television Systems Committees) television signals, may contain one or more digital television streams that carry television information like video, audio, caption text or other television information. When the television signals travel in the air, there are various factors, like noises and distortions by different transmission paths, affecting their signal characteristics. That is, the television signals arrived at a television apparatus 120 have different signal characteristics from that are just generated by the television broadcasting station 110.

Moreover, even all broadcasting stations disposed for covering different areas are under the same television standard, these broadcasting stations may still produce television signals with different characteristics. For example, broadcasting stations may contain different compatible machines or these machines may be under different conditions. Such characteristics field data are important for designing and adjusting real products of both the broadcasting stations 110 and the television apparatus 120. The television apparatus 120 is capable of generating test samples and sending these test samples to the remote server 130. When these test samples arrive at the remote server 130, engineers may perform different experiments and analysis on these test samples. Some television standards define an uplink channel for a television receiver to transmit data. In such case, the test samples may be transmitted via such uplink channel. Alternatively, test samples may be transmitted to the remote server via another network like Internet, if the remote server 130 is not disposed as a portion of television broadcasting network.

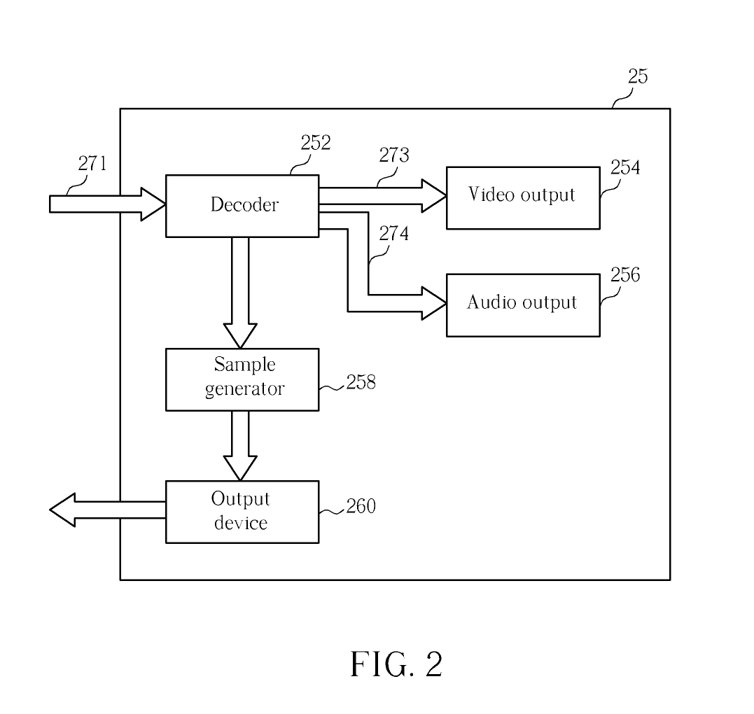

FIG. 2 illustrates a television apparatus 25, as an example for the television apparatus 120 in FIG. 1. The television apparatus 25 has a decoder 252, a video output 254, an audio output 256, a sample generator 258 and an output device 260.

The decoder 252 decodes a received television stream 271 to a video stream 273 and an audio stream 274. The two devices of the video output 254 and the audio output 256 receive and play the video stream 273 and the audio stream 274, respectively. The decoder 252 may contain a tuner, a demodulator, a television stream parser and/or a television stream processor. The decoder 252 as well as the video output 254 and the audio output 256 may be implemented wholly with hardware circuits or partly with hardware circuits and partly with associated software codes. The video output 254 may refer to as containing color processing circuits, a display controller and even a display. The audio output 256 may refer to as containing D/A converter, an amplifier and even a speaker. Persons skilled in the art may adapt their television decoding and playing devices with the following described sample generator 258 and the output device 260. The decoder 252, the video output 254 and the audio output 256 may be referred to as a television player which decodes and plays the received television stream 271.

There may be several stages of decoding for the decoder 252, and test samples may be extracted from any desired stage. For example, if a designer wants to acquire raw data received from an antenna of the television apparatus 25, the raw data may be directed to the sample generator 258 for generating test samples that are sampled in part or as in whole from the raw data. After the antenna, the raw data moves on and may be demodulated into an intermediate frequency in the decoder 252. It is also possible to redirect such signal to the sample generator 258. After demodulation, the intermediate frequency may be further sampled, parsed into one or more than data streams by the decoder 252. In any of such stages, designers may also redirect desired streams to the sample generator 258. In other words, the test samples may represent signal characteristics of the raw data received by an antenna and may represent processing quality of the decoder 252 so that designers know how the decoder 252 perform at the location where the television apparatus 25 is disposed. The test samples are transmitted by the output device 260 to a remote server as illustrated in FIG. 1.

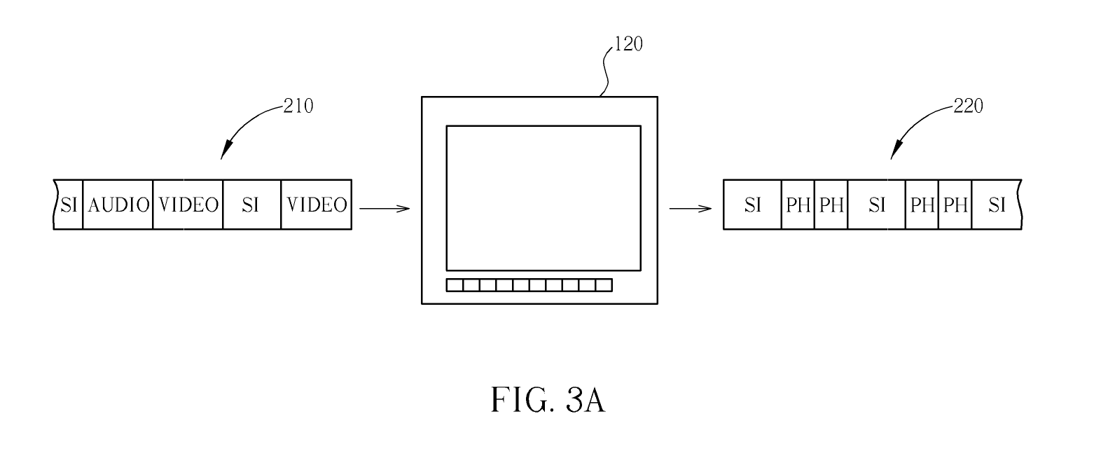

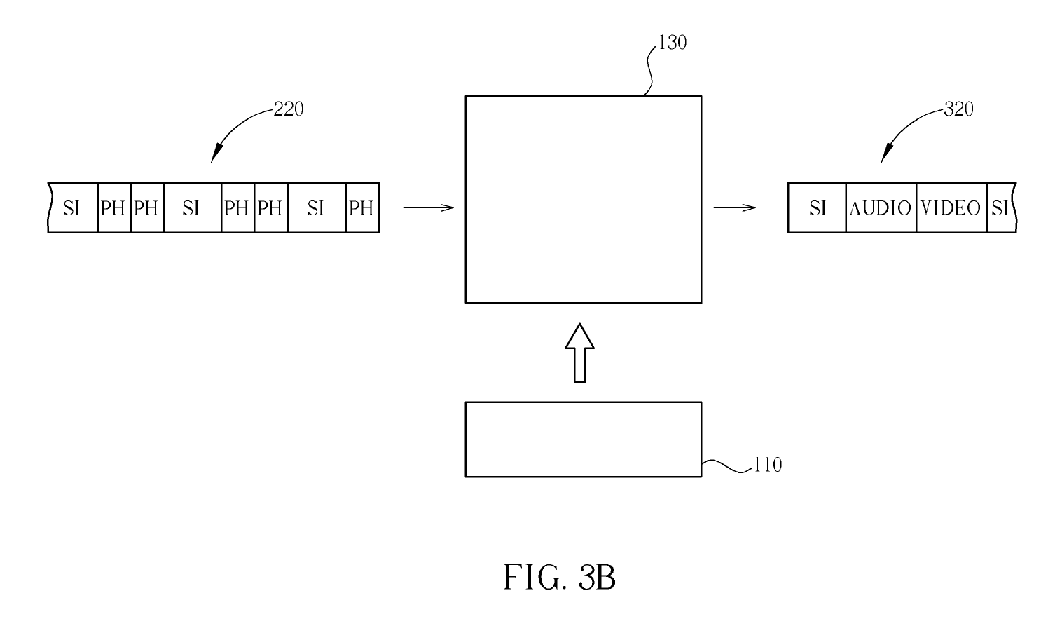

FIG. 3A illustrates an example of generating test samples 220 based on a received television stream 210. As mentioned above, there may be several stages during decoding a received television stream from an antenna. In FIG. 3, the received television stream 210 is parsed in to streams of data blocks of SI, AUDIO and VIDEO. Usually, a complete television stream is large and designers may replace certain contents of the received data stream 210 with placeholders (PH) when generating the test samples 220. With such, the test samples 220 may have smaller size than the original received television stream 210. This is particularly useful when the actual contents of the received television stream 210 are not critical for analyzing signal characteristics.

In addition, due to law regulations, it may violate copyright law if reproducing copyrighted material such as audio and video. If such concern arises, the test samples may remove copyrighted materials and replace them with padding patterns.

FIG. 3B illustrates how the remote server 130 reconstructs a test television stream 320 based on the test samples 220. In the reconstructed test television stream, the placeholder (PH) is replaced with certain AUDIO and VIDEO data blocks for testing.

It is noted that the remote server 130 may be disposed at the same location or even the same machine as the television broadcasting station 110. In such case, the output device 260 in FIG. 2 may need to package the test samples with the formats of an uplink channel of the television network of the television broadcasting station 110. In other cases, when the remote server 130 is located in another network other than the television network of the television broadcasting station 110, the output device 260 may have a network interface, e.g. an Ethernet interface for connecting to the Internet. When this happens, test samples are packaged into data blocks under TCP/IP during transmission.

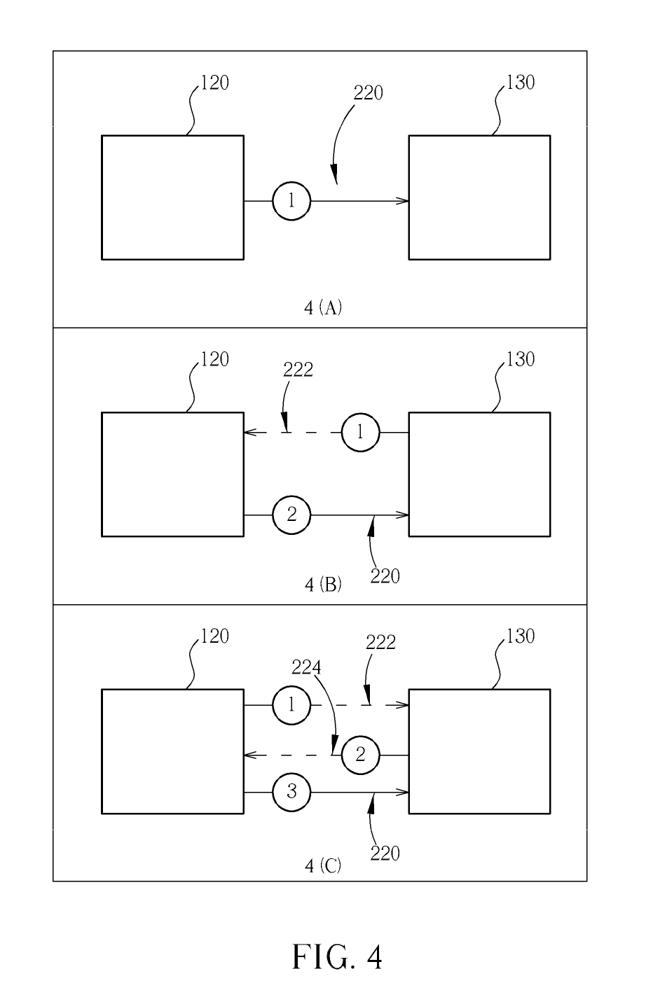

The communication between the remote server 130 and the television apparatus 120 may have several types. FIG. 4A, FIG. 4B and FIG. 4C illustrate three types of communications between the remote server 130 and the television apparatus 120.

In FIG. 4A, the television apparatus 120 automatically transmits the test samples 220 to the remote server 130 such that testing of the reconstructed television stream can commence immediately. In FIG. 4B, the television apparatus 120 first receives a test stream request 222 from the remote server 130. In the next step, the television apparatus 120 transmits the test samples 220. In FIG. 4C, the television apparatus 120 first sends a test stream request 222 to the remote server 130. Upon acknowledgement 224 of the test stream request from the remote server 130 in the second step, the television apparatus 120 transmits the test samples 220 to the remote server 130 in the third and final step.

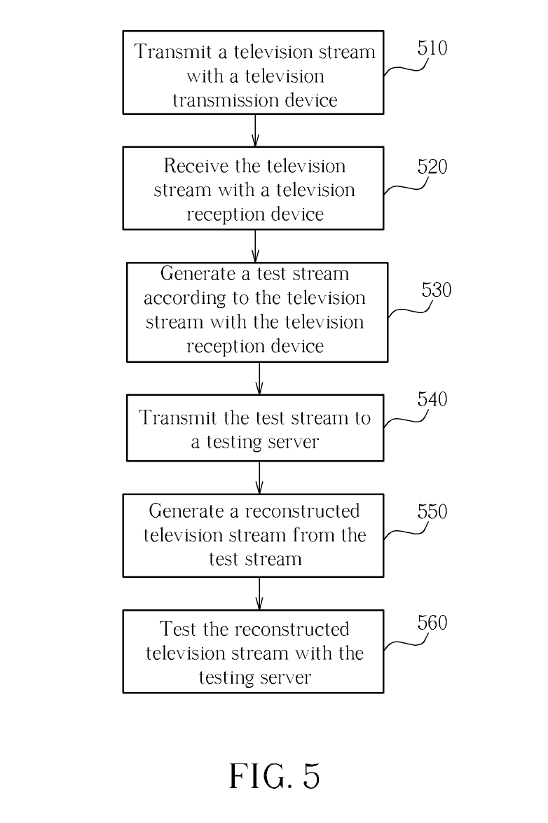

A method for testing a digital television (DTV) network is shown in the flow chart of FIG. 5. Provided that substantially the same result is achieved, the steps of process 500 need not be in the exact order shown and need not be contiguous, that is, other steps can be intermediate. The method for testing a digital television network comprises:
Step 510: Transmit a television stream with a television transmission device.
Step 520: Receive the television stream with a television reception device.
Step 530: Generate a test stream according to the television stream with the television reception device.
Step 540: Transmit the test stream to a testing server.
Step 550: Generate a reconstructed television stream from the test stream.
Step 560: Test the reconstructed television stream with the testing server.

The present invention therefore eliminates or limits the need to perform field trials in testing television transmission signals at reception sites. This allows for a substantial cost and time savings when testing a television stream signal at a reception site. This is accomplished through a direct analysis of a reconstructed television stream, based on a transmitted television stream received at a test site. The reconstructed television stream can then be used as test data to simulate the television stream received at the respective reception site. Using this technique, there is no need to visit each test site to extract the television stream signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A television apparatus for facilitating collection of field data from a location where the television apparatus receives a received television stream, comprising:
a television player for decoding and playing a received television stream;
a sample generator for generating test samples based on the received television stream, the test samples representing signal characteristics of the received television stream; and
an output device for sending the test samples to a remote server for performing analysis on the test samples.

2. The television apparatus of claim 1, wherein the test samples also represents processing quality of the television player.

3. The television apparatus of claim 1, wherein the output device is connected to an upstream channel of a television network for sending the test samples to the remote server, the received television stream being broadcasted via the television network.

4. The television apparatus of claim 1, wherein the output device is a network interface for transmitting the test samples to the remote server via a network other than a television network that broadcasts the received television stream to the television apparatus.

5. The television apparatus of claim 1, further comprising:
a switcher for enabling the sample generator and the output device for generating the test samples and sending the test samples to the remote server.

6. The television apparatus of claim 1, wherein the sample generator removes copyright contents from the received television stream for generating the test samples.

7. The television apparatus of claim 1, wherein the sample generator replaces a portion of the received television stream with placeholders for generating the test samples so as to decrease the size of the test samples, and the placeholders contains information for reconstructing a test television stream according to the test samples.

8. The television apparatus of claim 1, further comprising:
a GPS device coupled to the sample generator for adding position information in the test samples.

9. The television apparatus of claim 1, further comprising:
a setting interface for inputting position information to be added in the test samples.

10. The television apparatus of claim 1, wherein the received television stream is under ATSC standard.

11. The television apparatus of claim 1, wherein the output device sends the test samples upon receipt of a request from the remote server.

12. The television apparatus of claim 1, wherein the output device sends a notice to the remote server and sends the test samples upon receipt of acknowledgement from the remote server.

13. The television apparatus of claim 1, wherein the output device automatically sends the test samples according to a setting of the sample generator.

14. The television apparatus of claim 1, wherein the test samples are used for analyzing processing of the television player.

15. The television apparatus of claim 1, wherein the test samples are used for analyzing signal characteristics of a broadcasting station that broadcasts the received television stream to the television apparatus.

16. A method for performing field trial for television apparatuses, comprising:
disposing television apparatuses with test function at different locations, wherein each television apparatus is capable of decoding and playing a received television stream and generating test samples back to a remote server;
collecting the test samples at the remote server; and
analyzing the test samples.

17. The method of claim 16, further comprising:
reconstructing the test samples into a test television stream, wherein the test samples contain placeholders for reducing the size of the test samples.

18. The method of claim 16, wherein the test television apparatuses removes copyright materials when generating the test samples.

19. The method of claim 16, wherein the television stream is under ATSC standard.

20. The method of claim 16, wherein the television apparatus has a switch to enable or disable generating and sending the test samples.

21. The method of claim 16, wherein the test samples are composed of a plurality of parts collected from a plurality of the television apparatuses for reconstruct an original stream while these parts are overlapped.
